(19) United States
(12) Patent Application Publication
(10) Pub. No.: US 2008/0020640 A1
(43) Pub. Date: Jan. 24, 2008

(54) Electrical connector with shell

(75) Inventor: George (HuanYi) Zhang, Irvine, CA (US)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/492,148

(22) Filed: Jul. 24, 2006

(51) Int. Cl. H01R 13/648

(52) U.S. Cl. 439/607

(57) ABSTRACT

An electrical connector (100) includes an insulated housing (1), a number of terminals (2) received in the insulated housing (1), a metal shell (3) assembled to the insulated housing and a circuit substrate (4). The insulated housing includes a top wall, a bottom wall, a rear wall and a pair of side walls interconnecting with the top wall, the bottom wall and the rear wall to enclose a hollow with an opening. The terminals align in two distinct rows (21, 22) along transversal direction and the circuit substrate (4) with a number of conductive traces (41, 42) thereon. The metal shell (3) together with the insulated housing (1) are mounted on the circuit substrate (4).

### BACKGROUND OF THE INVENTION

1. Field of the Invention

The present invention generally relates to an electrical connector, and more particularly to an electrical connector with a metal shell.

2. Description of Related Art

The SFF Committee is an ad hoc group formed to address storage industry needs in a prompt manner. When formed in 1990, the original goals were limited to defining de facto mechanical envelopes within which disk drives can be developed to fit compact computer and other small products. SFF-8087 defines a free (plug) cable connector and a fixed (receptacle) right angle connector mating with the plug cable connector. The receptacle right angle connector includes an insulated housing receiving a plurality of contacts, a metal shell and a circuit substrate to which the receptacle right angle connector is mounted. However, as the insulated housing and the metal shell are respectively assembled to the circuit substrate and it may be inconvenient for users to use such connector. For example, U.S. Pat. No. 6,517,382 B2 discloses a receptacle for a pluggable module including a conductive housing having a front portion, a back wall, a bottom wall, and side walls and defining a cavity for receiving the pluggable module and a receptacle connector mounted on a printed circuit board. The bottom wall has a bottom opening to receive the receptacle connector, and the front portion has a front opening to receive the pluggable module to mate with the receptacle connector. However, it may be inaccurate to insert the pluggable module to the receptacle connector as the cavity of the receptacle connector is relative long. The insertion of the pluggable module is prone to departing from its proper roadway.

Hence, an improved electrical connector with a metal shell is highly desired to overcome the disadvantages of the related art.

### SUMMARY OF THE INVENTION

Accordingly, an object of the present invention is to provide an electrical connector with improved structure to make it easy and convenient to assemble an electrical connector to a circuit substrate.

Another object of present invention is to provide an electrical connector with improved structure to make a complementary connector inserting into the electrical connector more easily and accurately.

In order to achieve the object set forth, an electrical connector in accordance with the present invention comprises an insulated housing, a plurality of terminals received in the insulated housing and a metal shell. The metal shell includes an upper wall and a pair of transversal walls extending downwardly from the upper wall to form a body portion, each of the transversal wall including board locks extending downwardly therefrom, a pair of arms extending rearward from the transversal walls and defining a space therebetween. The insulated housing is integrally assembled between the arms of the metal shell.

Other objects, advantages and novel features of the invention will become more apparent from the following detailed description when taken in conjunction with the accompanying drawings.

### BRIEF DESCRIPTION OF THE DRAWINGS

FIG. 1 is an exploded, perspective view of an electrical connector in accordance with the first embodiment of the present invention;

FIG. 2 is a view similar to FIG. 1, but viewed from another aspect;

FIG. 3 is an assembled, perspective view of the electrical connector;

FIG. 4 is an assembled, perspective view of the electrical connector similar to FIG. 3, but viewed from different aspect;

FIG. 5 is an assembled view of the electrical connector and a complementary connector;

FIG. 6 is a cross-section view taken along longitudinal direction of the mated electrical connector and the complementary connector; and

FIG. 7 is an assembled, perspective view of an electrical connector in accordance with the second embodiment of the present invention.

### DETAILED DESCRIPTION OF THE INVENTION

Reference will now be made in detail to the preferred embodiment of the present invention.

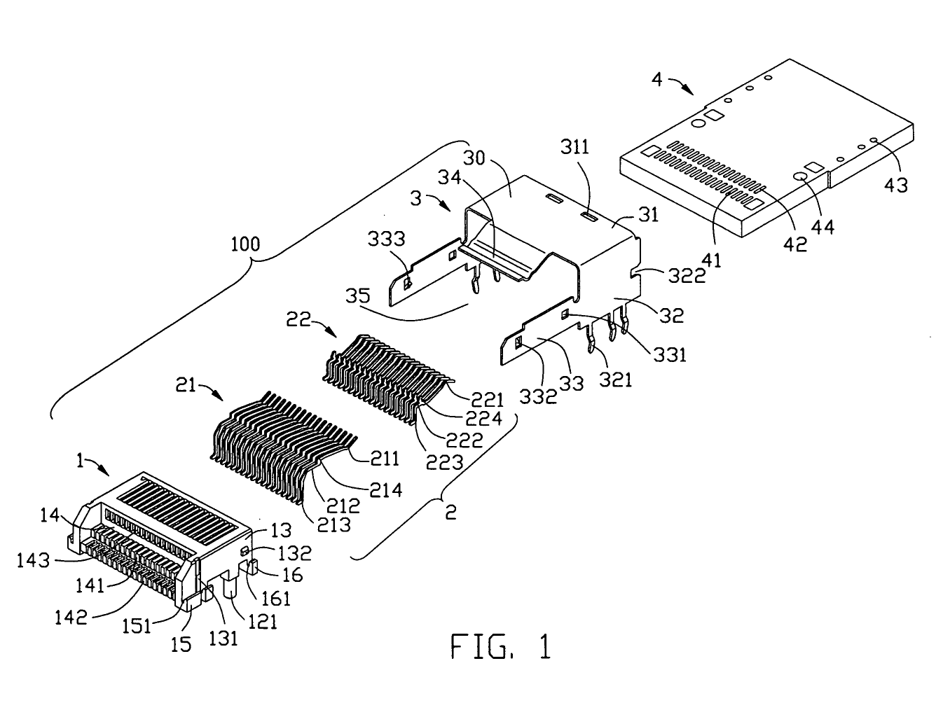

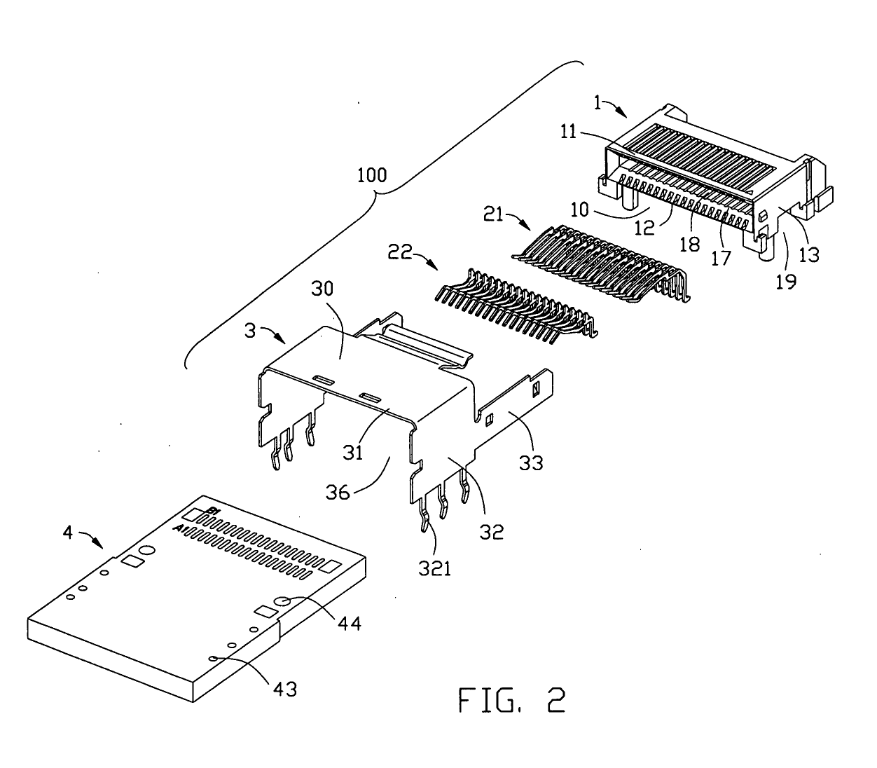

Referring to FIGS. 1-2, an electrical connector 100 for mounting on a circuit substrate 4 in accordance with the first embodiment of the present invention comprises an insulated housing 1, a plurality of contacts 2 respectively arranged in two rows along a vertical direction and received in the insulated housing 1, and a metal shell 3 assembled to the insulated housing 1.

The insulated housing 1 comprises a top wall 11, a bottom wall 12, a rear wall 14 and a pair of side walls 13 interconnecting with the top wall 11, the bottom wall 12 and the rear wall 14. The top wall 11, the bottom wall 12, the pair of side walls 13 and the rear wall 14 cooperatively enclose a hollow 18. The hollow 18 has an enlarged front opening 17 and extends interiorly along mating direction. A pair of positioning posts 121 respectively extend downwardly from opposite lateral sides of the bottom wall 12 and adjacent to the front opening 17. The front portions of the side walls 13 form a pair of projections 132 and the opposite rear portions form a pair of depression portions 131 mainly extending along vertical direction, respectively. A pair of first bulges 15 and a pair of second bulges 16 laterally extend outward from the lower parts of the side walls 13, and are located adjacent to the front portion and rear portion of the side walls 13, respectively. A pair of first grooves 151 are formed between the pair of first bulges 15 and side walls 13, and a pair of second grooves 161 are formed between the pair of second bulges 15 and side walls 13, respectively. Each side wall 13 with part of lower middle portion is cut to form a gateway 19. A top portion of the rear wall 14 defines a plurality of terminal passages 143 in a row along a transversal direction. Part of the rear wall 14 is cut to form a step 141 and a plurality of protrusions 142 align in a row along transversal direction and every two adjacent protrusions 142 are separated by a certain distance. The insulated housing 1 further defines a recess 10 below the bottom wall 12 distinct from the hollow 18.

The terminals 2 comprise a plurality of first set of terminals 21 and second set of terminals 22 arranged in two distinct rows along vertical direction. Either the first set of terminals 21 or the second set of terminals 22 align along transversal direction. Each terminal 21 comprises a body portion 212, a connecting portion 214 extending upwardly from a front end of the body portion 212, a contacting portion 211 firstly slantways extending forwardly and downwardly from a tip of the connecting portion 211, then slantways extending forwardly and upwardly, a rear portion 213 firstly extending downwardly from a rear end of the body portion 212, then extending rearward. Each terminal 22 comprises a body portion 222, a contacting portion 221 firstly slantways extending forwardly and upwardly from a front end of the body portion 222, then slantways extending forwardly and downwardly, a rear portion 223 firstly extending downwardly from a rear end of the body portion 222, then extending rearward and a retention portion 224 extending upwardly from a connecting portion between the contacting portion 221 and the body portion 222.

The metal shell 3 comprises an upper wall 31 and a pair of transversal walls 32 connecting with the upper wall 31 to form a substantially an inverted U-shape body portion 30, a pair of arms 33 respectively extending rearward from the lower part of the transversal walls 32 and a spring member 34 firstly extending rearward and downwardly from middle part of rear edge of the upper wall 31, then extending rearward and upwardly to form a lowest pressing portion. The arms 33 define a space 35 therebetween and the distance between the arms 33 is substantially equal to the width of the insulated housing 1. Thus the insulated housing 1 can be disposed in the space 35 and the arms 33 respectively engage with the side walls 13 of the insulated housing 1. The inverted U-shape body portion 30 defines a receiving space 36 adapted for leading the insertion of a complementary connector 200. A pair of locking apertures 311 for latching with latching portions 206 of the complementary connector 200 and a pair of cutouts 322 for guiding the insertion of the complementary connector 200 are respectively defined in the front parts of the upper wall 31 and the transversal walls 32. Each cutout 322 is substantially rectangular-type with a front opening. A pair of first through holes 331 are defined in the front part of the arms 33 and a pair of second through holes 332 are defined in the relative rear part of the arms 33, respectively. A pair of spring tabs 333 respectively extend from lower edges of the second through hole 332, and extend into the space 35. Three pairs of curved board locks 321 respectively extend downwardly from the bottom edge of the transversal walls 32. The board locks 321 can also serve for grounding paths.

The circuit substrate 4 has a plurality of conductive traces arranged in distinct first set of conductive traces 41 and second set of conductive traces 42. A pair of positioning holes 44 and three pairs of circular holes 43 are spaced arranged before the positioning holes 44 of the circuit substrate 4.

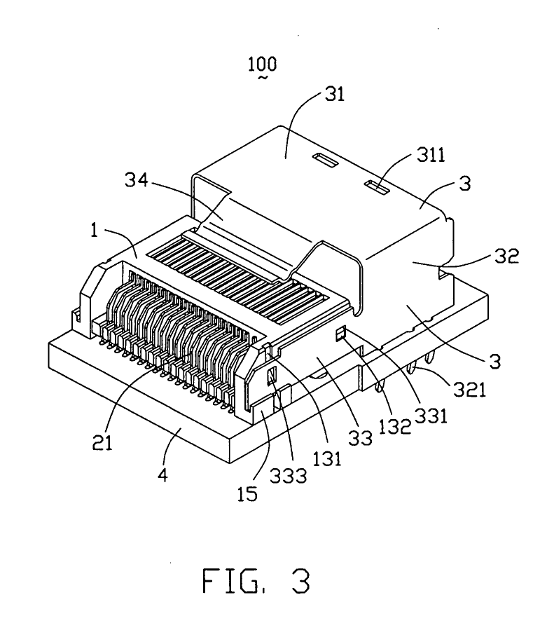

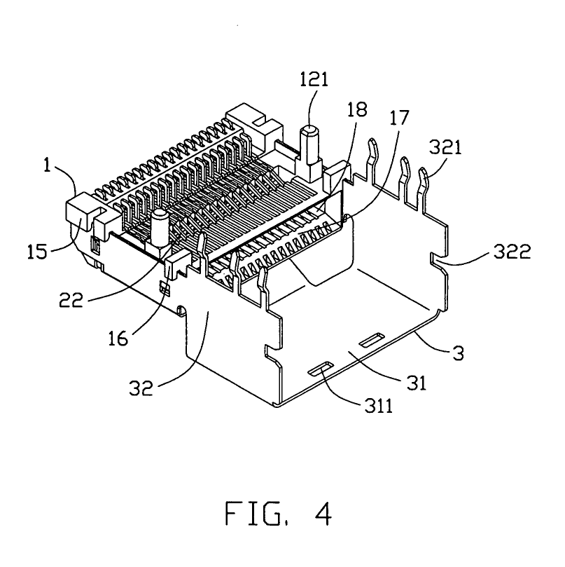

Referring to FIGS. 3-4 in conjunction with FIGS. 1-2, when assembly, the first set of terminals 21 are assembled to the insulated housing 1 along a front-to-back direction, with the contacting portions 211 disposed in the hollow 18, the connecting portions 214 received in the terminal passages 143 of the rear wall 14, the body portions 212 disposed on the step 141 and rear portions 213 respectively sandwiched between two adjacent protrusions 142. While, the second set of terminals 22 are assembled to the insulated housing 1 along a vertical direction perpendicular to the front-to-back direction, with the contacting portions 221 disposed in the hollow 18 to face the contacting portions 211 of the first set of terminals 21, the retention portions 224 retained in the bottom wall 12 of the insulated housing 1 and the rear portions 223 disposed in the rear section of the recess 10. Secondly, the metal shell 3 is assembled to the insulated housing 1, with the insulated housing 1 disposed between the space 35, bottom edges of the arms 33 sandwiched by the first grooves 151 and the second grooves 161 respectively. The first through holes 331 lock with the projections 132 on the side walls 13 and the spring tabs 333 engage with the depression portions 131 in the side walls 13. Thirdly, the insulated housing 1 and the metal shell 3 are together assembled to the circuit substrate 4, with ends of the rear portions 213, 223 respectively disposed on the conductive traces 41, 42, the positioning posts 121 received in the corresponding positioning holes 44 and board locks 321 inserted into the corresponding circular holes 43 for positioning the electrical connector 100 to the circuit substrate 4. Fourthly, the ends of rear portions 213, 223 are soldered to the conductive traces 41, 42 by surface mount technology (SMT) manner. The board locks 321 are also soldered to the circular holes 43 of circuit substrate 4. Gateways 19 of the insulated housing 1 facilitate the air flow in soldering process to improve the quality of solder.

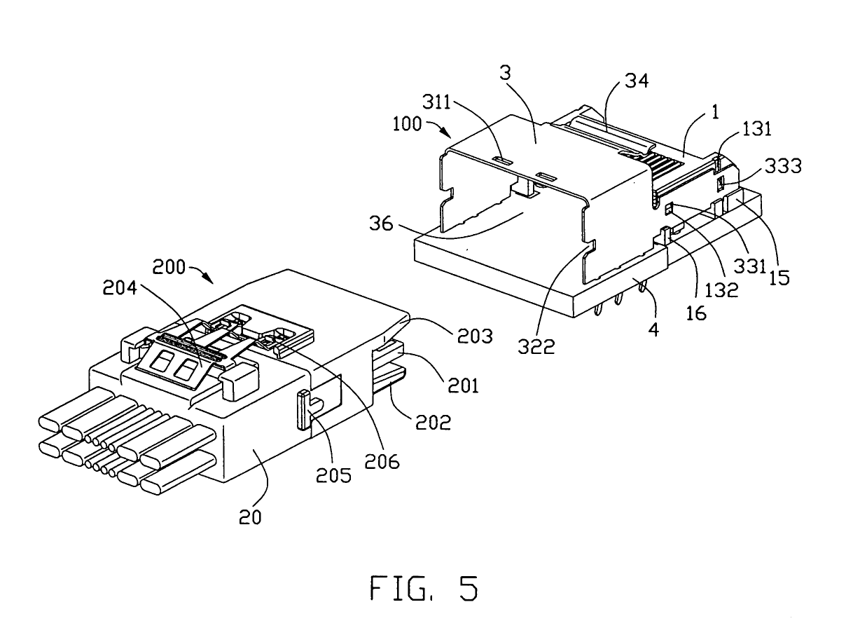

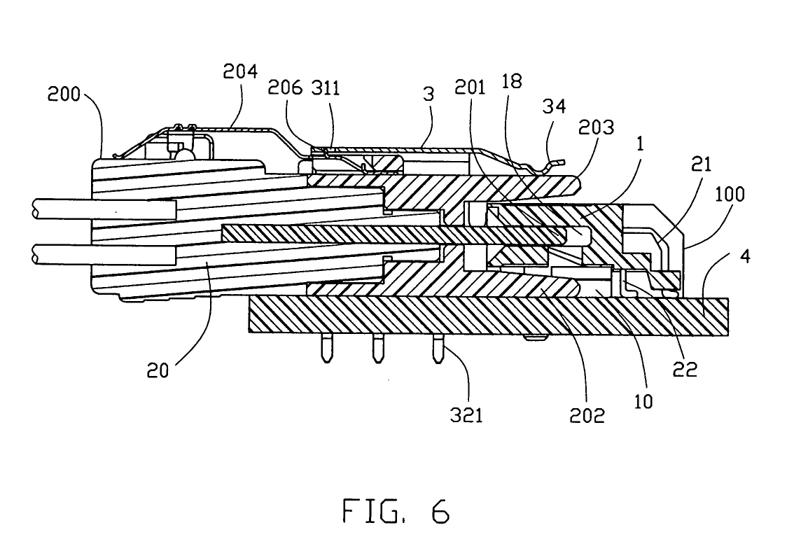

Referring to FIGS. 5-6, the complementary connector 200 comprises an insulated housing 20, a first protruding member 203 and a second protruding member 202 extending forwardly from an upper portion of the insulated housing 20 and lower portion of the insulated housing 20 respectively, and a printed circuit board 201 with a plurality of conductive pads (not shown) thereon received in the insulated housing 20 with front portion exposed between the first protruding member 203 and the second protruding member 202. A cantilever-type latching member 204 with the pair of latching portions 206 is mounted on the top surface of the insulated housing 20 and a pair of T-shape ear parts 205 are formed on the transversal surfaces of the insulated housing 20. When complementary connector 200 mates with the electrical connector 100, via the leading of the metal shell 3 and cooperation between the T-shape ear parts 205 and the cutouts 322, the insulated housing 20 is housed in the receiving space 36, with the printed circuit board 201 received in the hollow 18 of the insulated housing 1 between the first set of terminals 21 and the second set of terminals 22, the conductive traces (not shown) electrically contacting with the mating portions 211, 221 of the terminals 21, 22, the latching portions 206 latch with the locking apertures 311 of the metal shell 3 and the lowest portion of the spring member 34 pressing against the first protruding member 203 to prevent rotation of the complementary connector 200 and to make the engagement of the complementary connector and the electrical connector 100 more stable.

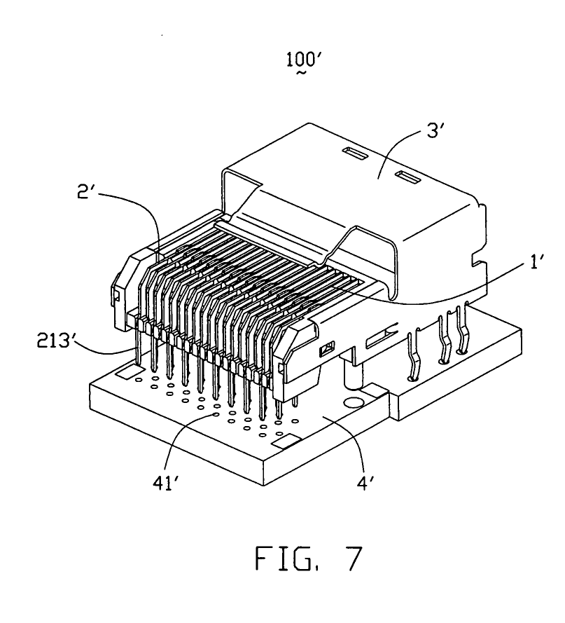

Referring to FIG. 7, an electrical connector 100′ in accordance with the second embodiment of the present invention is illustrated. The electrical connector 100′ for mounting on a circuit substrate 4′ also comprising an insulated housing 1′, a plurality of contacts 2′ respectively arranged in two rows along a vertical direction and received in the insulated housing 1′, and a metal shell 3′ assembled to the insulated housing 1′. In contrast with the electrical connector 100 of the first embodiment of the present invention, the elements of the electrical connector 100′ are similar to those of the electrical connector 100, except that the rear portions 213′ of the terminals 2′ are different from the rear portions 213, 223. The rear portions 213′ of the terminals 2′ are straight, while the rear portions 213, 223 are curved. So, there is a little difference in assembly between the electrical connector 100′ and the electrical connector 100. The rear portions 213′ are inserted into receiving holes 41′ of the circuit substrate 4′ and soldered therein, and this is a well known through hole (T/H) solder manner.

It is to be understood, however, that even though numerous characteristics and advantages of the present invention have been set forth in the foregoing description, together with details of the structure and function of the invention, the disclosure is illustrated only, and changes may be made in detail, especially in matters of shape, size, and arrangement of parts within the principles of the invention to the full extent indicated by the broad general meaning of the terms in which the appended claims are expressed.

1. An electrical connector assembly adapted for mounting to a circuit substrate comprising:
a metal shell comprising an upper wall and a pair of transversal walls extending downwardly from the upper wall to form a body portion, each of the transversal wall comprising board locks extending downwardly therefrom adapted for connecting the metal shell with the circuit substrate, a pair of arms extending rearward from the transversal walls and defining a space therebetween;
an insulated housing;
a plurality of terminals being separated into first set of terminals and second set of terminals, wherein the first set of terminals and the second set of terminals are assembled to the insulated housing along different directions which are perpendicular to each other; and
the insulated housing integrally assembled between the arms of the metal shell, with the body portion of the metal shell located forwardly of the insulated housing.

2. (canceled)

3. The electrical connector assembly as claimed in claim 1, wherein the first set of terminals are assembled to the insulated housing along a front-to-back direction and the second set of terminals are assembled to the insulated housing along a vertical direction.

4. The electrical connector assembly as claimed in claim 1, wherein the first set of terminals comprises connecting portions and rear portions, wherein the insulated housing defines a plurality of terminal passages and protrusions, and wherein the connecting portions of the terminals are received in the terminal passages and each rear portion of corresponding terminal is sandwiched between two adjacent protrusions,

5. The electrical connector assembly as claimed in claim 1, wherein the insulated housing comprises a bottom wall, and wherein the second set of terminals comprises retention portions received in the bottom wall.

6. The electrical connector assembly as claimed in claim 1, wherein the terminals are soldered to the circuit substrate via surface mount technology manner.

7. (canceled)

8. The electrical connector assembly as claimed in claim 1, wherein the body portion of the metal shell defines a receiving space adapted for housing an insulated housing of the complementary connector.

9. The electrical connector assembly as claimed in claim 1, wherein the insulated housing defines a pair of side walls, wherein each side wall forms at least one bulge and a groove formed between the side wall and the bulge, and wherein a bottom edge of corresponding arm is sandwiched by the groove.

10. The electrical connector assembly as claimed in claim 9, wherein each arm defines a first through hole and each side wall of the insulated housing forms a projection to lock with the first through hole.

11. The electrical connector assembly as claimed in claim 9, wherein each side wall of the insulated housing defines a depression portion and each arm forms a spring tab for engaging with the depression portion.

12. The electrical connector assembly as claimed in claim 1, wherein the insulated housing defines a hollow extending interiorly along mating direction.

13. An electrical connector providing a connection between a circuit substrate and a complementary connector, the circuit substrate having a plurality of conductive traces thereon, the complementary connector comprising a first and a second protruding members respectively extending forwardly from an upper portion and a lower portion of the insulated housing and a printed circuit board with a plurality of conductive pads thereon received in the insulated housing with front portion exposed between the first protruding member and the second protruding member, said electrical connector comprising:
a metal shell comprising an upper wall and a pair of transversal walls extending downwardly to form a body portion, a pair of arms extending rearward from the transversal walls and defining a space therebetween;
an insulated housing having a plurality of walls that cooperatively defining a hollow with an opening;
the insulated housing integrally assembled between the arms of the metal shell; and
the body portion of the metal shell defines a receiving space housing the insulated housing of the complementary connector.

14. The electrical connector as claimed in claim 13, wherein the terminals are separated into first set of terminals and second set of terminals, wherein the first set of terminals and the second set of terminals are assembled to the insulated housing along different directions which perpendicular to each other.

15. The electrical connector as claimed in claim 13, wherein the front parts of each transversal walls of the metal shell define a pair of cutouts adapted for cooperation with the T-shape ear parts formed on the complementary connector.

16. The electrical connector as claimed in claim 13, wherein a spring member extends rearward from upper wall of the metal shell adapted for pressing against a first protruding portion of a complementary connector.

17. The electrical connector as claimed in claim 13, wherein the upper wall of the metal shell defines a pair of locking apertures adapted for latching with latching portions of latching member of the complementary connector.

18-20. (canceled)

21. The electrical connector assembly as claimed in claim 1, wherein the body portion defines a receiving space in front of a mating port which is defined in the housing, and a plug connector is coupled to the shell and the housing under a condition that a mating region of the plug connector is mated within the mating port, wherein a locking structure is formed on a front portion of the upper wall of the body portion to latchably engage a deflectable latch of the plug connector, and a pressing structure is formed on a rear portion of the upper wall of the body portion to downwardly press an exterior wall of the plug connector which is used to protect the mating region.

22. The electrical connector assembly as claimed in claim 21, wherein a gap is defined between the upper wall and the housing in a vertical direction to receive said exterior wall of the plug connector therein.

23. The electrical connector assembly as claimed in claim 21, wherein said pair of arms are equipped with retention structures to fasten the housing thereto.

24. An electrical connector adapted for mounting to a circuit substrate, comprising:
an insulated housing;
a plurality of terminals received in the insulated housing a metal shell comprising an upper wall and a pair of transversal walls extending downwardly from the upper wall to form a body portion, a pair of arms extending rearward from the transversal walls and defining a space therebetween and a spring member extending rearward from upper wall of the metal shell and disposed over the front section of the insulated housing; and
the insulated housing integrally assembled between the arms of the metal shell, with the body portion of the metal shell disposed forwardly of the insulated housing.

25. An electrical connector adapted for mounting to a circuit substrate, comprising:
an insulated housing having a front mating section with a mating slot therein;
a plurality of terminals received in the insulated housing
a U-shaped metal shell comprising an upper wall and a pair of transversal walls extending downwardly from the upper wall to form a body portion, a spring member extending rearward from upper wall of the metal shell and disposed over the front mating section of the insulated housing; and
the insulated housing integrally assembled to the metal shell on two lateral sides thereof, the body portion of the metal shell disposed forwardly of the insulated housing; wherein
an upper space is formed above the front mating section under the spring member for receiving a portion of a plug connector, a lower space is formed under the front mating section above the substrate for receiving another portion of the plug connector; wherein
no portions of the housing extend into a receiving cavity under the body portion.
